(19) United States
(12) Patent Application Publication
(10) Pub. No.: US 2022/0136293 A1
(43) Pub. Date: May 5, 2022

(54) LOCKING ASSEMBLY AND BOX HAVING LOCKING ASSEMBLY

(71) Applicant: HONGFUJIN PRECISION ELECTRONICS(TIANJIN)CO.,LTD., Tianjin (CN)

(72) Inventors: TZU-CHENG YANG, New Taipei (TW); HUANG-JYUN LU, New Taipei (TW)

(21) Appl. No.: 17/198,663

(22) Filed: Mar. 11, 2021

(30) Foreign Application Priority Data
Oct. 29, 2020 (CN) 202011187825.0

(51) Int. Cl. E05C 9/04; E05C 9/08; B65D 55/14

(52) U.S. Cl. CPC E05C 9/04; B65D 55/14; E05C 9/085

(57) ABSTRACT

A locking assembly includes a first locking member, a rotating shaft for driving the first locking member to move, and a shell member. The first locking member is movably coupled to the shell member. An elastic element is coupled between the first locking member and the shell member. A first protruding portion is provided on an outer peripheral side of the rotating shaft. One end of the first locking member is provided with a first abutting portion. The first protruding portion abuts against the first abutting portion. The elastic element is used to maintain mutual contact between the first protruding portion and the first abutting portion. The first protruding portion rotates along with the rotating shaft to drive the first locking member to extend from or retract into the shell member.

### FIELD

The subject matter herein generally relates to locking assemblies, and more particularly to a locking assembly for locking a box.

### BACKGROUND

Generally, a locking assembly includes a rotating part to drive a locking part to move to achieve the function of locking or unlocking. Additional transmission components, such as gear sets or multiple transmission rods, need to be coupled between the rotating part and the locking part. Therefore, a structure and installation process of the transmission components are relatively complicated, which decreases production efficiency of the locking assembly and increases production costs.

### BRIEF DESCRIPTION OF THE DRAWINGS

Implementations of the present disclosure will now be described, by way of embodiments, with reference to the attached figures.

FIG. 1 is a schematic perspective view of an embodiment of a box including a locking assembly.

FIG. 2 is an exploded view of the box shown in FIG. 1.

FIG. 3 is a schematic perspective diagram of the locking assembly shown in FIG. 2.

FIG. 4 is an exploded view of the locking assembly shown in FIG. 3.

FIG. 5 is a schematic perspective view of a rotating shaft shown in FIG. 4 viewed from another angle.

FIG. 6 is a schematic perspective view of a shell member of the locking assembly shown in FIG. 2 viewed from another angle.

FIG. 7 is a schematic perspective view of the box shown in FIG. 1 in an unlocked state.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or another word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

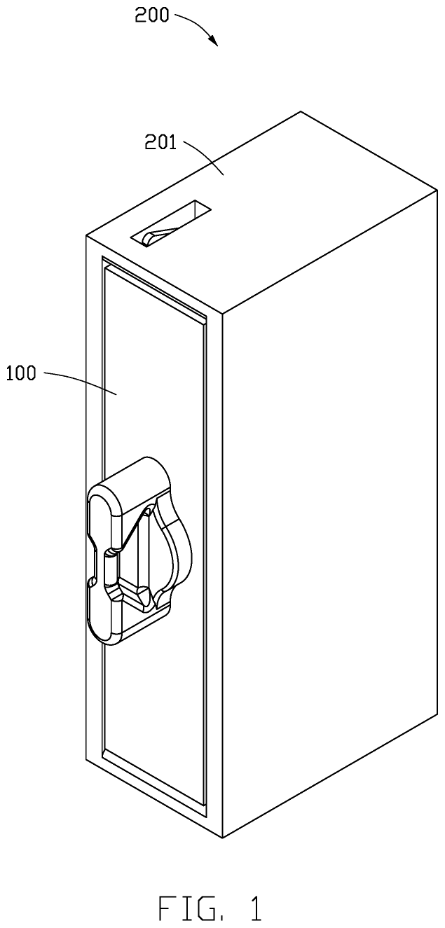

Referring to FIGS. 1-3, in one embodiment, a box 200 includes a housing 201 and a locking assembly 100. The locking assembly 100 is movably arranged in the housing 201 to lock or unlock the housing 201.

The locking assembly 100 includes a first locking member 10, a rotating shaft 20, and a shell member 30. The first locking member 10 is movably coupled to the shell member 30. The rotating shaft 20 is used to drive the first locking member 10 to move. An elastic element 40 is coupled between the first locking member 10 and the shell member 30. One end of the first locking member 10 includes a first abutting portion 11 facing the rotating shaft 20, and an outer peripheral side of the rotating shaft 20 is provided with a first protruding portion 21. The first protruding portion 21 abut the first abutting portion 11. The elastic element 40 is used to maintain mutual contact between the first protruding portion 21 and the first abutting portion 11. Specifically, one end of the elastic element 40 is coupled to the first locking member 10, and another end of the elastic element 40 is fixed to the shell member 30. When the elastic member 40 is in a stretched state, the first locking member 10 and the shell member 30 maintain a relative motion trend, and the first protruding portion 21 of the rotating shaft 20 abuts a side of the first abutting portion 11 facing the elastic element 40, so that the first abutting portion 11 and the first protruding portion 21 abut against each other under the action of elastic tension. The first protruding portion 21 is used to rotate together with the rotating shaft 20 to drive the first locking member 10 to extend out or retract into the shell member 30. When the first locking member 10 extends out of the shell member 30, the housing 201 is engaged with the first locking member 10, and the locking assembly 100 locks the housing 201. When the first locking member 10 is retracted into the shell member 30, the first locking member 10 is separated from the housing 201, and the locking assembly 100 unlocks the housing 201.

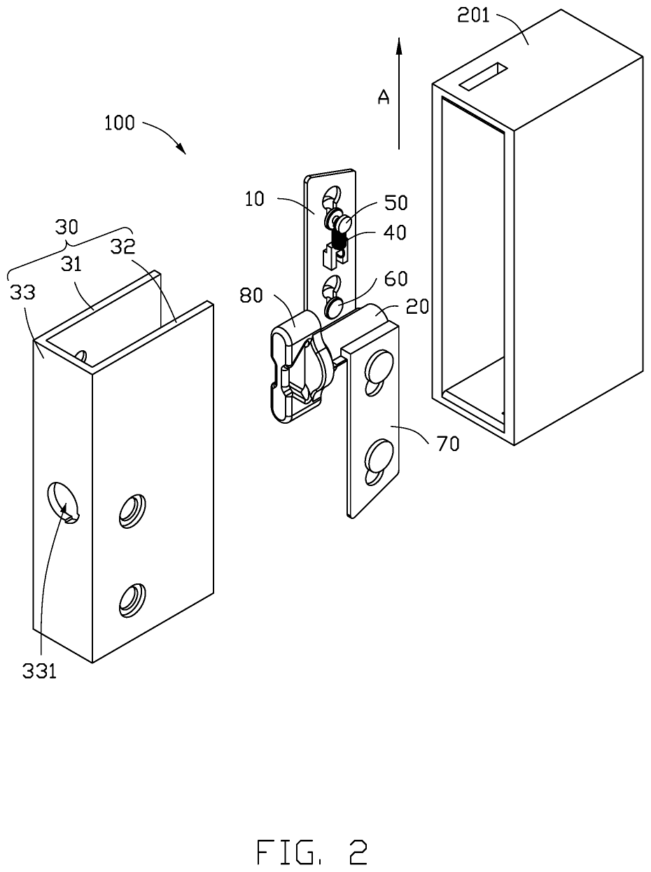

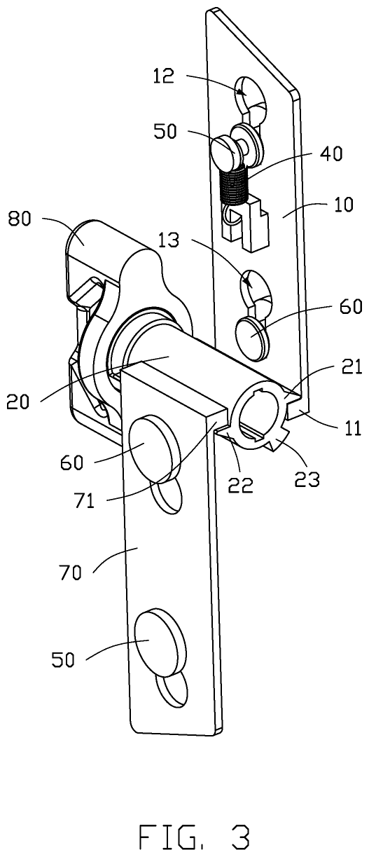

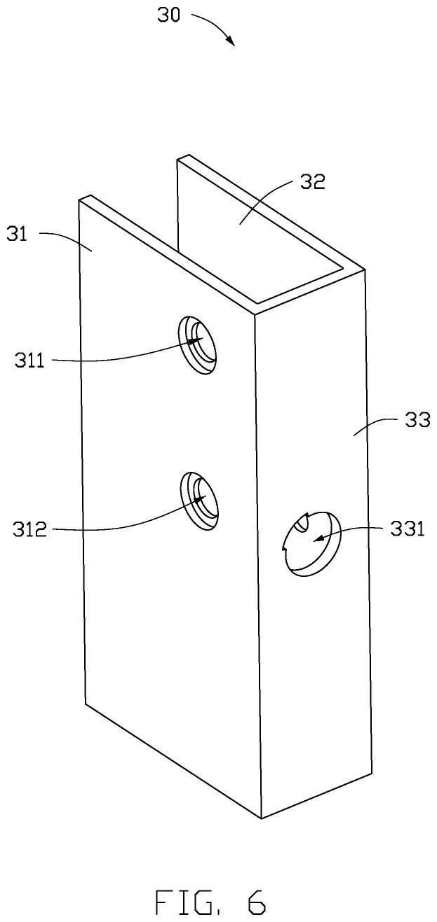

Referring to FIGS. 2 and 3, the housing 30 includes a first side plate 31, a second side plate 32 and a cover plate 33. The first side plate 31 and the second side plate 32 are respectively arranged on two opposite sides of the cover plate 33 and are substantially perpendicular to the cover plate 33. The first locking member 10 is movably coupled to the first side plate 31. Specifically, the first locking member 10 is provided with a first through slot 12, and the first side plate 31 is provided with a first through hole 311 (shown in FIG. 6) corresponding to the first through slot 12. Along a length direction of the first locking member 10, a length of the first through slot 12 is greater than a length of the first through hole 311. The length direction of the first locking member 10 is indicated by arrow A in FIG. 2. The locking assembly 100 further includes a first connecting member 50. One end of the first connecting member 50 is fixed in the first through hole 311, and another end of the first connecting member 50 protrudes from the first through slot 12 and is movably arranged in the first through slot 12. One end of the elastic element 40 is coupled to the first connecting member 50, and another end of the elastic element 40 is coupled to the first locking member 10, so that the elastic element 40 is coupled between the first locking member 10 and the shell member 30 through the first connecting member 50. Taking the viewing angle of FIG. 3 as an example, when the rotating shaft 20 rotates to drive the first locking member 10 to move up and down relative to the first side plate 31, the first through slot 12 moves relative to the first connecting member 50, a length of the elastic element 40 changes relative to the movement of the first locking member 10, and the first protruding portion 21 remains in contact with the first abutting portion 11 under the action of elastic tension, so that the first locking member 10 and the rotating shaft 20 move synchronously.

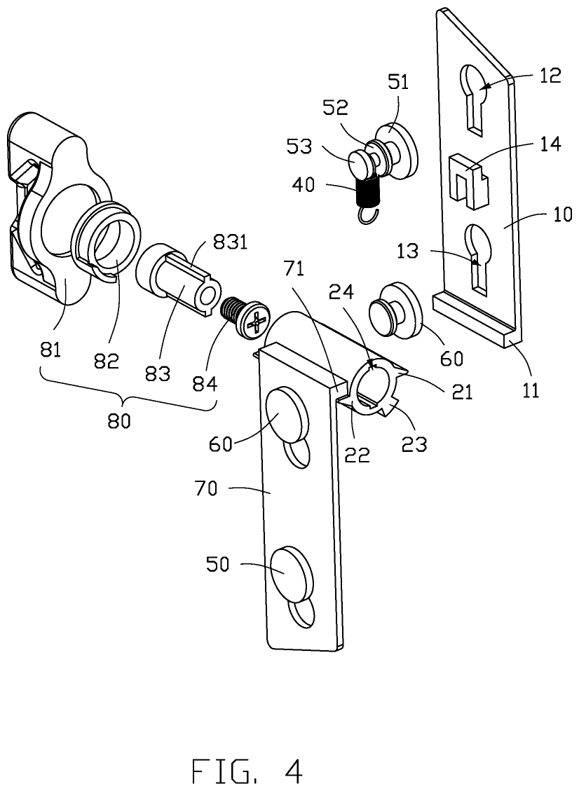

Referring to FIG. 4, the first locking member 10 is further provided with a hook 14. One end of the elastic element 40 is coupled to the end of the first connecting member 50 that protrudes from the first through slot 12, and another end of the elastic element 40 is detachably coupled to the hook 14, so that the hook 14 can be easily replaced in in the latch assembly 100. The first protruding portion 21 of the rotating shaft 20 abuts on the side of the first abutting portion 11 facing the elastic element 40. When the locking assembly 100 is in an initial state, the end of the first locking member 10 away from the rotating shaft 20 extends out of the shell member 30, the first connecting member 50 is located at a bottom end of the first through slot 12 toward the hook 14, and the elastic element 40 is in a naturally extended or stretched state. When the rotating shaft 20 rotates and the first protruding portion 21 presses the first abutting portion 11 to drive the first locking member 10 to move down, the first connecting member 50 is moved upward relative to the first locking member 10, the elastic element 40 is stretched, and the first abutting portion 11 keeps abutting against the first protruding portion 21 under the action of elastic force. When the first connecting member 50 is located at a top end of the first through slot 12 away from the hook 14, the first locking member 10 is completely retracted into the shell member 30.

The first connecting member 50 is substantially in the shape of a rivet and includes a first flange 51, a second flange 52, and a third flange 53 coaxially spaced apart. The first flange 51 abuts against a side of the first side plate 31 facing away from the first locking member 10 and is used for positioning the first connecting member 50 and the first side plate 31 to prevent the connecting member 50 from separating from the first side plate 31. The second flange 52 abuts against a side of the first locking member 10 facing away from the first side plate 31 to limit a movement of the first locking member 10 along an axial direction of the first connecting member 50 to prevent the first locking member 10 from shaking while moving up and down, thereby preventing the first locking member 10 from failing to enter a locked position on the box 200 correctly. The elastic element 40 is coupled between the second flange 52 and the third flange 53 to prevent parts from falling or shifting during movement.

Referring to FIGS. 4 and 6, the first locking member 10 is further provided with a second through slot 13, and the first side plate 31 is further provided with a second through hole 312 corresponding to the second through slot 13. Along the length direction of the first locking member 10, the second through slot 13 is arranged colinearly with the first through slot 12, and the second through hole 312 is arranged colinearly with the first through hole 311. The locking assembly 100 further includes a second connecting member 60. One end of the second connecting member 60 is fixedly arranged in the second through hole 312, and another end of the second connecting member 60 is movably arranged in the second through slot 13. When the first locking member 10 moves relative to the first side plate 31, the second connecting member 60 moves synchronously with the first connecting member 50 to stabilize the movement of the first locking member 10, thereby reducing shaking of the first locking member 10 and ensuring accuracy of the locking assembly 100.

Referring to FIGS. 2 and 4, the locking assembly 100 further includes a second locking member 70. A structure of the second locking member 70 is substantially the same as a structure of the first locking member 10. The second locking member 70 is movably coupled to the second side plate 32 of the shell member 30. The outer peripheral side of the rotating shaft 20 is further provided with a second protruding portion 22. The second protruding portion 22 is arranged on an opposite side of the rotating shaft 20 as the first protruding portion 21. An end of the second locking member 70 includes a second abutting portion 71 facing the rotating shaft 20 to abut against the second protruding portion 22. The first locking member 10 and the second locking member 70 are arranged substantially in parallel, and installation directions of the first locking member 10 and the second locking member 20 are opposite. When the rotating shaft 20 rotates, the first locking member 10 and the second locking member 70 are driven to move in opposite direction, so that the locking assembly 100 realizes a function of two-way locking and improves stability of locking. The outer peripheral side of the rotating shaft 20 is further provided with a limiting portion 23. The limiting portion 23 is spaced apart from the first protruding portion 21 and the second protruding portion 22. The first abutting portion 11 is located between the limiting portion 23 and the first protruding portion 21 and abuts against a side of the first protruding portion 21 toward the limiting portion 23. The second abutting portion 71 abuts against a side of the second protruding portion 22 away from the limiting portion 23. The limiting portion 23 is used to limit a rotation range of the rotating shaft 20, maintain mutual contact between the rotating shaft 20 and the first locking member 10 and the second locking member 70, and prevent the first protruding portion 21 and the second protruding portion 22 from respectively separating from the first abutting portion 11 and the second abutting portion 71 due to excessive rotation of the rotating shaft 20.

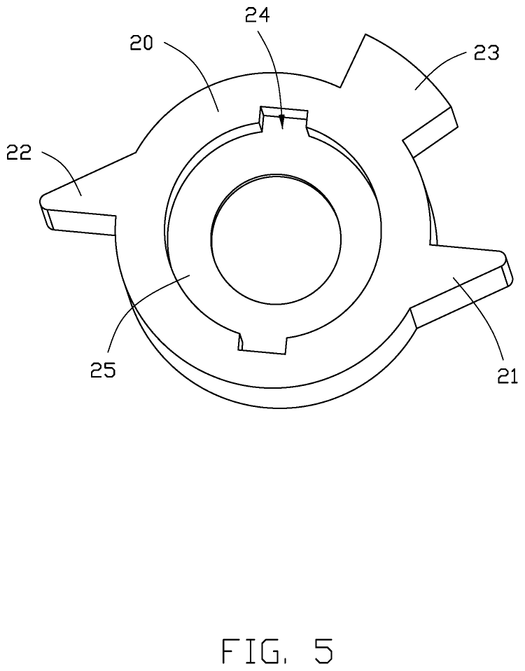

The cover plate 33 is provided with a mounting hole 331, and the rotating shaft 20 is rotationally mounted in the mounting hole 331. The locking assembly 100 further includes a knob assembly 80. The knob assembly 80 is arranged on an outer side of the cover plate 33 and is coupled to the rotating shaft 20 for driving the rotating shaft 20 to rotate. The knob assembly 80 includes a knob 81, a sleeve 82, a connecting shaft 83, and a fastener 84. The sleeve 82 is fixedly coupled to the knob 81. The rotating shaft 20 is substantially a hollow structure with open ends. One end of the connecting shaft 83 is fixedly arranged in the sleeve 82, and another end of the connecting shaft 83 is inserted into the rotating shaft 20 and fixedly coupled to the rotating shaft 20 to cause the rotating shaft 20 to move synchronously with the knob 81. Referring to FIGS. 4 and 5, an inner wall of a central hole of the rotating shaft 20 is provided with a positioning groove 24 and a positioning flange 25. An outer peripheral side of the connecting shaft 83 is provided with a positioning protrusion 831. The positioning protrusion 831 is received in the positioning groove 24 to prevent relative rotation between the connecting shaft 83 and the rotating shaft 20. An end of the connecting shaft 83 inserted into the rotating shaft 20 and the fastener 84 are respectively located on opposite sides of the positioning flange 25. The fastener 84 and the connecting shaft 83 are threadedly coupled together and held against the positioning flange 25 to fix the rotating shaft 20 and the connecting shaft 83 together, thereby preventing the rotating shaft 20 from separating from the end of the connecting shaft 83. The connecting shaft 83 and the fastener 84 are coupled together inside the rotating shaft 20, which makes a structure of the knob assembly 80 and the rotating shaft 20 more compact, which is beneficial to reduce a size of the locking assembly 100.

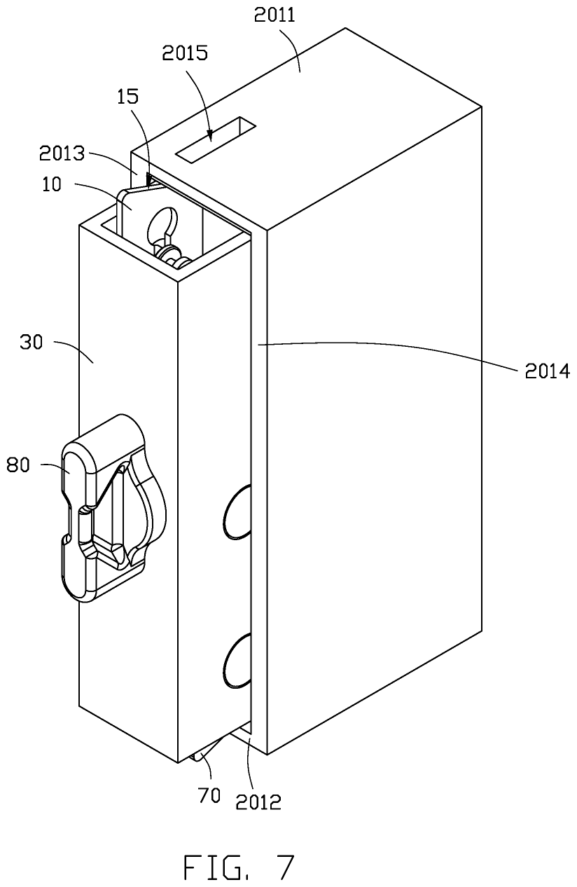

Referring to FIG. 7, the housing 201 of the box 200 includes a top wall 2011, a bottom wall 2012, a first side wall 2013, and a second side wall 2014. The first side wall 2013 and the second side wall 2014 are coupled to the top wall 2011 and the bottom wall 2012. Each of the top wall 2011 and the bottom wall 2012 is provided with a locking slot 2015, and the two locking slots 2015 correspond to the first locking member 10 and the second locking member 70, respectively. The first side plate 31 of the housing 30 is arranged facing the first side wall 2013, and the second side plate 32 is arranged facing the second side wall 2014. A width of the cover plate 33 is less than or equal to a distance between an inner side of the first side wall 2013 and an inner side of the second side wall 2014, so that an open side of the housing 201 is closed. A matching relationship between the shell member 30 and the housing 201 makes a structure of the box 200 compact and simple, without the need for additional components to close the housing 201.

When the locking assembly 100 locks the housing 201, the first locking member 10 and the second locking member 70 respectively protrude from the upper and lower ends of the shell member 30 and engage with the corresponding locking slot 2015. An end of the first locking member 10 away from the rotating shaft 20 is further provided with an inclined surface 15. When the locking assembly 100 is pushed into the housing 201, a side of the top wall 2011 presses against the inclined surface 15 to press the first locking member 10 into the shell member 30, and when the first locking member 10 is aligned with the through slot 2015, the first locking member 10 extends out of the end of the shell 30 and enters into the through slot 2015 to lock the shell 201 to the locking assembly 100. The arrangement of the inclined surface 15 simplifies a locking process between the housing 201 and the locking assembly 100. The locking assembly 100 is simply pushed into the housing 201 to lock the locking assembly 100 and the housing 201 together without turning the knob 81.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A locking assembly comprising:
a first locking member;
a rotating shaft configured for driving the first locking member to move; and
a shell member, the first locking member movably coupled to the shell member; wherein:
an elastic element is coupled between the first locking member and the shell member;
a first protruding portion is on an outer peripheral side of the rotating shaft;
one end of the first locking member comprises a first abutting portion;
the first protruding portion abuts against the first abutting portion;
the elastic element is configured to maintain mutual contact between the first protruding portion and the first abutting portion; and
the first protruding portion rotates along with the rotating shaft to drive the first locking member to extend from or retract into the shell member.

2. The locking assembly of claim 1, wherein:
the outer peripheral side of the rotating shaft further comprises a limiting portion;
the limiting portion and the first protruding portion are spaced apart; and
the first abutting portion is between the limiting portion and the first protruding portion.

3. The locking assembly of claim 1, further comprising a first connecting member, wherein:
a first through slot is defined in the first locking member;
a first through hole is defined in the shell member; and
one end of the first connecting member is fixed in the first through hole, and another end of the first connecting member is movably arranged in the first through slot.

4. The locking assembly of claim 3, wherein:
a hook is on the first connecting member; and
one end of the elastic element is coupled to the first connecting member, and another end of the elastic element is coupled to the hook.

5. The locking assembly of claim 3, wherein:
the housing comprises a first side plate, a second side plate, and a cover plate;
the first side plate and the second side plate are respectively arranged on opposite sides of the cover plate;
the first locking member is movably coupled to the first side plate; and
the rotating shaft is mounted on the cover plate.

6. The locking assembly of claim 5, further comprising a second locking member, wherein:
the second locking member is movably coupled to the second side plate;
the rotating shaft further comprises a second protruding portion;
the second protruding portion abuts against one end of the second locking member; and
the rotating shaft drives the first locking member and the second locking member to move in opposite directions.

7. The locking assembly of claim 1, further comprising a knob assembly, wherein:
the rotating shaft is coupled to the knob assembly; and
the knob assembly is configured to drive the rotating shaft to rotate.

8. The locking assembly of claim 7, wherein:
the rotating shaft is a hollow structure;
the knob assembly comprises a knob, a sleeve, and a connecting shaft;
the sleeve is fixedly coupled to the knob; and
one end of the connecting shaft is fixedly inserted in the sleeve, and another end of the connecting shaft is inserted into the rotating shaft and fixedly coupled to the rotating shaft.

9. The locking assembly of claim 8, wherein:
an inner wall of the rotating shaft defines a positioning groove;
an outer peripheral side of the connecting shaft comprises a positioning protrusion; and
the positioning protrusion is received in the positioning groove.

10. A box comprising:
a housing; and
a locking assembly movably arranged in the housing for locking or unlocking the housing, the locking assembly comprising:
a first locking member;
a rotating shaft configured for driving the first locking member to move; and
a shell member, the first locking member movably coupled to the shell member; wherein:
an elastic element is coupled between the first locking member and the shell member;
a first protruding portion on an outer peripheral side of the rotating shaft;
one end of the first locking member comprises a first abutting portion;
the first protruding portion abuts against the first abutting portion;
the elastic element is configured to maintain mutual contact between the first protruding portion and the first abutting portion; and
the first protruding portion rotates along with the rotating shaft to drive the first locking member to extend from or retract into the shell member.

11. The box of claim 10, wherein:
the outer peripheral side of the rotating shaft is further provided with a limiting portion;
the limiting portion and the first protruding portion are spaced apart; and
the first abutting portion is between the limiting portion and the first protruding portion.

12. The box of claim 11, wherein:
the locking assembly further comprises a first connecting member;
a first through slot is defined in the first locking member;
a first through hole is defined in the shell member; and
one end of the first connecting member is fixed in the first through hole, and another end of the first connecting member is movably arranged in the first through slot.

13. The box of claim 12, wherein:
a hook is on the first connecting member; and
one end of the elastic element is coupled to the first connecting member, and another end of the elastic element is coupled to the hook.

14. The box of claim 13, wherein:
the housing includes a first side plate, a second side plate, and a cover plate;
the first side plate and the second side plate are respectively arranged on opposite sides of the cover plate;
the first locking member is movably coupled to the first side plate; and
the rotating shaft is mounted on the cover plate.

15. The box of claim 14, wherein:
the locking assembly further comprises a second locking member;
the second locking member is movably coupled to the second side plate;
the rotating shaft further comprises a second protruding portion;
the second protruding portion abuts against one end of the second locking member; and
the rotating shaft drives the first locking member and the second locking member to move in opposite directions.

16. The box of claim 15, wherein:
the locking assembly further comprises a knob assembly;
the rotating shaft is coupled to the knob assembly; and
the knob assembly is configured to drive the rotating shaft to rotate.

17. The box of claim 16, wherein:
the rotating shaft is a hollow structure;
the knob assembly comprises a knob, a sleeve, and a connecting shaft;
the sleeve is fixedly coupled to the knob; and
one end of the connecting shaft is fixedly inserted in the sleeve, and another end of the connecting shaft is inserted into the rotating shaft and fixedly coupled to the rotating shaft.

18. The box of claim 17, wherein:
an inner wall of the rotating shaft comprises a positioning groove;
an outer peripheral side of the connecting shaft comprises a positioning protrusion; and
the positioning protrusion is received in the positioning groove.

19. The box of claim 18, wherein:
the housing comprises a top wall, a bottom wall, a first side wall, and a second side wall;
the first side wall and the second side wall are coupled to the top wall and the bottom wall; and
each of the top wall and the bottom wall defines a locking slot, and the two locking slots correspond to the first locking member and the second locking member, respectively.

20. The box of claim 19, wherein:
the first side plate of the housing is arranged facing the first side wall;
the second side plate is arranged facing the second side wall; and
a width of the cover plate is less than or equal to a distance between an inner side of the first side wall and an inner side of the second side wall.
